(19) United States
(12) Patent Application Publication
(10) Pub. No.: US 2007/0193463 A1
(43) Pub. Date: Aug. 23, 2007

(54) Device and method for controlling the temperature of a rotating body

(75) Inventors: Eduard Hoffmann, Bobingen (DE); Thomas Kandlbinder, Augsburg (DE); Harald Mittelhammer, Augsburg (DE)

Correspondence Address: COHEN PONTANI LIEBERMAN & PAVANE LLP, Suite 1210, 551 Fifth Avenue, New York, NY, 10176, US

(73) Assignee: MAN Roland Druckmaschinen AG

(21) Appl. No.: 11/701,568

(22) Filed: Feb. 2, 2007

(30) Foreign Application Priority Data
Feb. 4, 2006 (DE) 10 2006 005 151.3

(51) Int. Cl. B41F 23/04

(52) U.S. Cl. 101/487

(57) ABSTRACT

A cylinder of a printing press is provided with an axial bore in which a fluid supply line is supported by spacers forming a return duct having an annular cross section, so that the inlet and the outlet of the fluid are at the same end of the cylinder.

### BACKGROUND OF THE INVENTION

1. Field of the Invention

The present invention concerns a device and a method for controlling the temperature of a rotating body, i.e., especially for controlling the temperature of a cylinder, e.g., a blanket cylinder of a printing press.

2. Description of the Related Art

In printing presses, the rolling of two cylinders on each other can cause local heating. For example, this can be the case with a blanket cylinder that is fitted with a rubber blanket or rubber sleeve and is rolling on a plate cylinder. The local heat input occurs especially in the area of contact of the blanket cylinder with the channel of the plate cylinder. The phenomenon of local heat input is referred to as the hot spot problem, which can also arise with blank cylinder/blanket cylinder printing units in the area of contact between the blanket cylinders.

The local heat input results in unbalanced linear expansion of the cylinder and thus to curvature of the cylinder, especially when the ratio of length to diameter is large. The curvature of the cylinder in turn leads to eccentric running during the rolling of the cylinder and thus to reduced printing quality in the production process of the printing press.

### SUMMARY OF THE INVENTION

Based on the above statement of the problem, the objective of the invention is to create a device or a method that counteracts reduced printing quality due to the development of hot spots.

In accordance with the invention, a rotating body, such as a cylinder and especially a blanket cylinder, is produced for a printing press, wherein the rotating body has at least one opening. The opening can be, for example, a bore subsequently produced in the cylinder. The bore is provided essentially in the axial direction of the rotating body and preferably coaxially within the rotating body. The purpose of the bore is to introduce a fluid into the rotating body and then remove it from the rotating body in order to control the temperature of the rotating body.

Since the development of a hot spot on the surface of a cylinder causes unbalanced heating of the cylinder, bending of the cylinder occurs, especially when the cylinder is long relative to its diameter. Unbalanced heat input does not occur if the temperature difference due to the hot spot is reduced or completely compensated. The bore that is provided makes it possible, in a way that is practicable and favorable from the standpoint of production engineering, to provide the cylinder with a mechanism for controlling its temperature. The use of a single bore for introducing and removing a fluid for controlling the temperature of the cylinder is a solution which is favorable from the standpoint of production engineering and allows the cylinder to be heated to a temperature that is not susceptible to curvature due to the development of hot spots on the surface of the cylinder.

In accordance with a refinement of the invention, a supply line with at least one inlet is provided in the bore inside the rotating body. The temperature-control fluid flows into the rotating body through the supply line, and the fluid flows out of the inlet that is provided and back out of the rotating body through the space between the bore and the supply line, i.e., along the inside surface of the bore.

In accordance with a first embodiment according to the invention, the bore in the rotating body or cylinder can pass completely through the rotating body. In this case, one end of the bore must then be closed with a suitable closure. As an alternative, the bore can be realized in such a way that it does not pass completely through the rotating body, i.e., the bore depth adapted to the cylinder provides for the closure at the second end of the cylinder.

This design makes it possible to provide both a supply line and a discharge line through a connector on one end face of the rotating body, i.e., in the case of a blanket cylinder, on the base of the blanket cylinder. The connector itself does not rotate, and the rotating body is rotatably supported on the connector. Fluid that has been adjusted to a desired temperature in a temperature-control system enters the rotating body through the connector.

In accordance with the first embodiment of the invention, at least one spacer can be provided between the supply line and the inner wall of the bore. The supply line can be supported on this spacer, but it is also possible for the supply line to be rotatably supported in the connector, so that it becomes unnecessary to provide spacers, or the manufacturing precision of the spacers can be lower. To allow a suitable amount of backflow of the fluid in the bore, the spacers can be additionally provided with flow-through zones, i.e., openings in the spacer.

In accordance with another embodiment of the invention, a different design can be chosen, so that the use of a supply line is merely optional. Specifically, if the bore passes completely through the rotating body, it becomes possible to introduce the fluid at one end of the rotating body and to discharge it again at the other end of the rotating body. This makes it necessary to provide two connectors, i.e., one at each end of the rotating body, which again allow relative movement between the rotating body and connectors.

In accordance with a modification of the invention, which is possible both for the design with the inlet and outlet at one end and for the design with the inlet at one end and the outlet at the other end, the surface of the inner wall of the bore is increased to improve the heat transfer to the rotating body. A baffle can be provided in the bore as this device for increasing the surface area, which divides the fluid into numerous separate streams, which then flow over the enlarged surface of the baffle. Moreover, it is also possible to reduce the flow rate of a fluid to extend the time available for transferring heat to the rotating body. The device for increasing the surface area or reducing the flow rate can be contrived either as a special baffle or as an alteration of the surface features of the bore carried out as a machining operation on the bore.

In accordance with another modification of the invention, a temperature-control system can be provided in the immediate proximity of the rotating body in addition to or instead of the temperature-control system customarily used in printing presses. The use of a temperature-control system in the vicinity of the rotating body makes it possible to reduce the delay time for heating the rotating body. The additional temperature-control system can be connected, for example, to a line of the printing press temperature-control system that runs to the rotating body to be heated. The additional temperature-control system can be, for example, an electric heat exchanger, which can be designed, for example, as a flow heater. Furthermore, it is possible to mount this flow heater parallel to the supply line of the printing press temperature-control system that runs to the rotating body, so that operation with or without the flow heater is possible.

In addition, the objective of the invention can be achieved by a method of the invention for controlling the temperature of a rotating body of a printing press. The printing press has rotating bodies that roll on one another and a temperature-control system for heating at least one rotating body. As described earlier, the rolling of the rotating bodies on each other generates heat on the surface of the heatable rotating body and as a result, in the most unfavorable case, only a portion of the surface of the heatable rotating body is heated to a first temperature. In accordance with the invention, the step of the method in which the rotating body is heated compensates unbalanced heat input on the surface, i.e., the development of hot spots.

In accordance with an advantageous modification of the invention, the temperature produced in the rotating body by the temperature-control system must be at least as high as the temperature on the surface of the rotating body. The rotating body is preferably already heated up before the start of printing or before other parts of the printing press are started up.

It is advantageous for the device of the invention to be based on a conventional cylinder design. In other words, since a bore can be made in a conventional cylinder, a multipart cylinder is not necessary, but rather a conventional cylinder can also be reshaped in connection with a retrofitting.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a sectional view of a blanket cylinder according to a first embodiment of the invention;

FIG. 2 shows a sectional view of a blanket cylinder according to a second embodiment of the invention; and

FIG. 3 shows a sectional view of a blanket cylinder that can be used to carry out the method of the invention.

### DETAILED DESCRIPTION OF THE PRESENTLY PREFERRED EMBODIMENTS

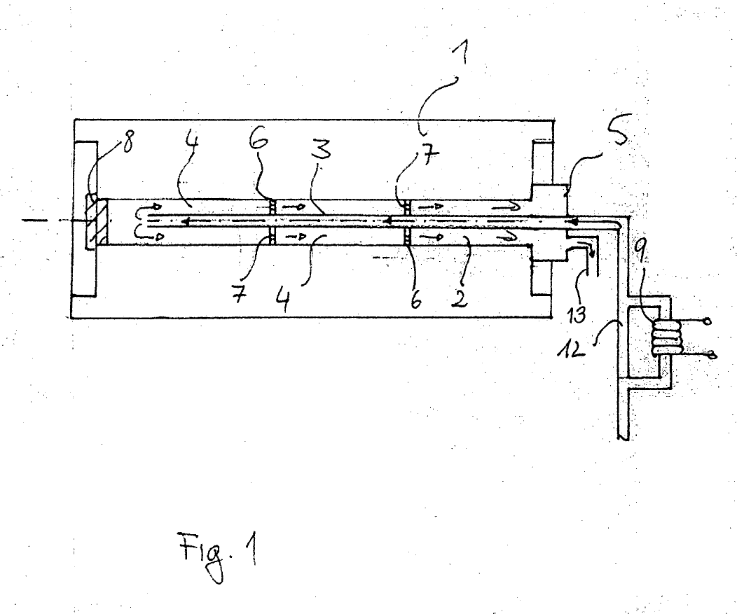

FIG. 1 shows a cross-sectional view of a blanket cylinder 1 with a bore 2 that passes through it. A supply line 3 is supported in the bore 2 on spacers 6. The spacers 6 have flow regions 7, which in the present case are formed as circular drill holes along the circumference of the spacer 6. The spacers 6 form a return duct 4 having an annular cross-section between the inside wall of the bore 2 and the supply line 3. The supply line 3 and return duct 4 are rotatably joined with the connector 5, which is rigidly mounted on a base of the blanket cylinder.

The connector 5 is preferably a rotationing union of the type sold by the Deublin Company of Waukegan, Ill. For the embodiment of FIG. 1, a Deublin 57 Series duo-flow union is especially suitable. Such a union can be fixed to a support framework of the rotating cylinder, and has sealed joints connecting the inlet line 12 and discharge line 13 to the supply line 3 and return duct 4 respectively.

Since the bore 2 passes completely through the blanket cylinder 1 in the illustrated embodiment, a closure 8 for closing one end of the bore is provided on the base of the blanket cylinder at the opposite end of the cylinder from the connector 5. In the vicinity of the temperature-control line 12, an additional temperature-control system 9 is provided parallel to the temperature-control line 12. The fluid supplied to the blanket cylinder can be heated more quickly via the bypass through the additional temperature-control system 9 by a suitable valve mechanism (not shown) in order to reduce the delay time during the heating of the blanket cylinder.

To heat the blanket cylinder, a heated fluid flows into the supply line 3 through the temperature-control line 12 and the connector 5. The supply line 3 has at least one inlet, preferably at the end of the supply line. In addition, a plurality of openings can be provided in the circumferential direction of the supply line. The temperature-control fluid flows back to the connector 5 in the space between the supply line 3 and the bore 2, and is removed from the connector 5 through a discharge line 13. Alternatively, the pipeline designed as a supply line in this embodiment could also be used as the discharge line, so that the direction of flow would be just the opposite of that described in connection with the embodiment illustrated here. Furthermore, it is also possible to dispense entirely with a supply line and to carry out the operation of flooding the bore 2 by means of the pressure of the entering fluid.

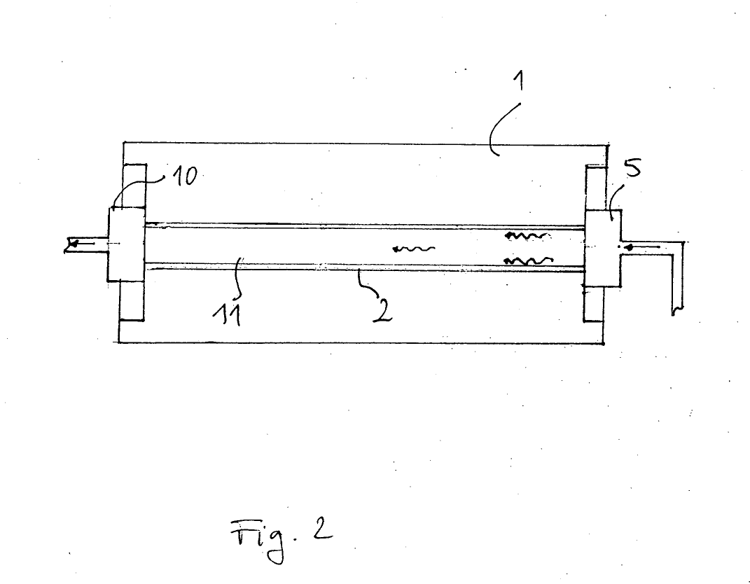

FIG. 2 shows a blanket cylinder 1 with a bore 2 that penetrates the entire length of the blanket cylinder. A connector 10 is provided at the opposite end from the connector 5. The fluid flows in through the connector 5 and flows back out through the connector 10. The connectors 5 and 10 are rigidly supported, and the blanket cylinder 1 is rotatably supported between them. A baffle 11 for increasing the surface area or reducing the flow rate is installed in the bore 2. The baffle 11 has an inner lamellar structure with the largest possible surface area on its outer circumference, so that the heat transfer from the fluid to the cylinder is optimized.

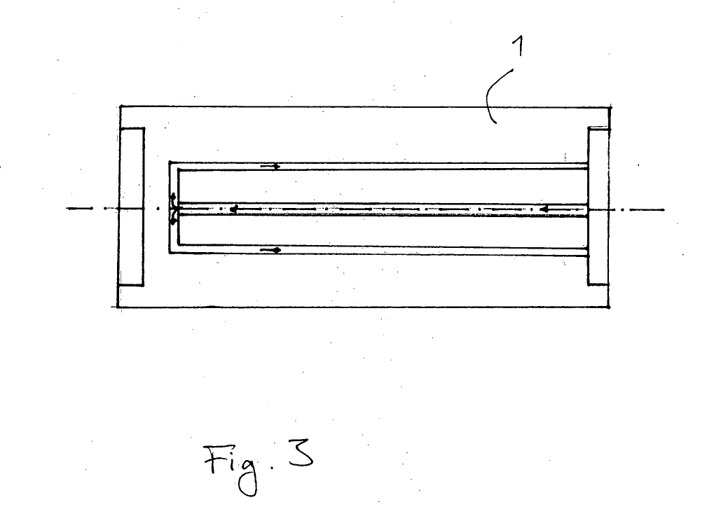

FIG. 3 shows a blanket cylinder with a design of a type that can also be used for the method of the invention. According to the method of the invention, the blanket cylinder illustrated in FIG. 3 is heated by a temperature-control system. Preferably, the blanket cylinder is heated to a temperature greater than or equal to the temperature produced by the development of the hot spots, which can also be carried out even before the start of printing. Therefore, with respect to the method claimed here, the heating method or heating devices that are used are unimportant. FIG. 3 shows a device that can be used for the method of the invention, namely, a blanket cylinder with supply and discharge lines, i.e., several bores that serve as supply and discharge lines. In addition, to realize the method of the invention, thermal energy can be transferred to an inner surface of a rotating body by heat conduction and/or radiation and/or convection. Of course, it is not absolutely necessary to transfer heat to the inner surface of the rotating body, but rather it is also possible to heat the outer surface of the rotating body. Furthermore, it is also conceivable to transfer thermal energy by heat conduction and/or radiation and/or convection in a temperature-control line to the rotating body, so that the transported fluid is heated. In a concrete realization, a temperature-control system can also be provided in the form of a heating element in the rotating body.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A rotating body of a printing press, the body having an axis of rotation and a opening extending parallel to said axis, said opening having an inlet and an outlet for permitting a fluid to flow through said body for controlling the temperature of said body.

2. The rotating body of claim 1 wherein the rotating body is a blanket cylinder.

3. The rotating body of claim 1 wherein said opening is coaxial with said axis of rotation.

4. The rotating body of claim 1 further comprising a supply tube located coaxially in said opening and forming an annular return duct between said supply tube and an inner wall of said opening, said annular return duct being connected to said outlet.

5. The rotating body of claim 4 further comprising a connector connecting said supply tube to a temperature control system which supplies fluid that has been adjusted to a desired temperature.

6. The rotating body of claim 5 wherein said temperature control system is located in proximity to said rotating body.

7. The rotating body of claim 4 wherein said supply tube is rotatably supported in said connector.

8. The rotating body of claim 4 comprising at least one spacer supporting said supply tube in said opening, each said spacer having at least one flow passage.

9. The rotating body of claim 1 wherein said opening passes completely through said rotating body, said opening having one end provided with a plug.

10. The rotating body of claim 8 wherein said opening passes completely through said rotating body, said opening having one end provided with said inlet and an opposed end provided with said outlet.

11. The rotating body of claim 10 comprising an inlet connector at said one end and an outlet connector at said opposed end, said connectors permitting said supply tube to rotate with said body, said connectors being connected to a temperature control system for supplying fluid to said inlet at a desired temperature.

12. The rotating body of claim 1 further comprising a baffle in said opening, said baffle having an increased surface area which increases heat transfer from said fluid to said rotating body.

13. The rotating body of claim 1 further comprising means for reducing the flow rate in the opening, thereby extending the time for transferring heat from the fluid to the body.

14. The rotating body of claim 1 wherein said opening is a bore.

15. A method of controlling the temperature of a first rotating body which rolls against a second rotating body in a printing press and heats a surface of the second rotating body to a first temperature, said method comprising:
heating said first rotating body by a temperature control system.

16. The method of claim 15 wherein said first rotating body is heated to a second temperature that is greater than or equal to the first temperature.

17. The method of claim 15 wherein said first rotating body is heated before printing begins.
